(19) United States
(12) Patent Application Publication
(10) Pub. No.: US 2018/0142478 A1
(43) Pub. Date: May 24, 2018

(54) HOT-PRESS MOLDING FORMALDEHYDE-FREE STONE-PLASTIC COMPOSITE PLATE

(71) Applicant: Bin Xu, Zhejiang (CN)

(72) Inventor: Bin Xu, Zhejiang (CN)

(21) Appl. No.: 15/315,146

(22) PCT Filed: Nov. 18, 2016
(86) PCT No.: PCT/CN2016/106449

§ 371 Date: Oct. 31, 2017

(51) Int. Cl. E04F 15/10; B32B 3/06; B32B 27/08; B32B 27/30; E04F 15/02

(52) U.S. Cl. CPC E04F 15/107; B32B 3/06; B32B 27/08; B32B 27/304; E04F 15/02038; E04F 2201/0547; B32B 2471/00; E04F 2201/0153; E04F 2201/023; E04F 2201/043; B32B 2264/10

(57) ABSTRACT

This application discloses a hot-press molding formaldehyde-free stone-plastic composite plate, which can be used as a plate, a ceiling, a door panel, a wall surface, a decorative sheet, and others in the field, and comprises a PVC material composite surface layer as a surface layer, a stone-plastic material layer as a middle layer and a PVC material bottom layer as a bottom layer; wherein the PVC material composite surface layer, the stone-plastic material layer and the PVC material bottom layer are sequentially arranged from a surface side to a bottom side and hot-press molded into a plate body; the finished products is good in stability, less deformation, waterproof, fire-prevent, anti-skid, flame retardant, wear-resisting, shock-resistant, high-temperature-resistant, long in life, formaldehyde-free, environmental friendly, safe etc.; the periphery side of the plate body is provided with a snap-fit connection structure easy to assemble and disassemble; the practicability of the product is greatly improved.

### CROSS-REFERENCE TO RELATED APPLICATIONS

The present application claims priority to and the benefit of Chinese Patent Application No. CN 201621090307.6, filed on Sep. 29, 2016, the entire content of which is incorporated herein by reference.

### BACKGROUND OF THE INVENTION

### 1. Field of the Invention

The invention relates to the field of stone-plastic decorative material, more specifically, to a hot-press molding formaldehyde-free stone-plastic composite plate.

### 2. Description of the Related Art

A solid wood floor, for example, has the following disadvantages: poor wear resistance, high price, low cost-performance, waste in wood resource; due to the high process requirements, the structure is complex, the quality difference is large, and the internal quality is not easy to tell; furthermore, in the process of producing the solid wood floor, the parquet glue must be used, in which the formaldehyde content is high, and the product's poor environmental protection and water damage is irreparable and it is not waterproof, fireproof, or flame-retarding, and it is ductile.

Take the conventional PVC floor as an example, it has the following disadvantages: easy expansion and shrinkage deformation of finished products, poor stability, easy damage of tongue and groove joints, poor impact strength, high requirements on the paving ground, complex process, and inconvenient of installation and maintenance.

Take the conventional WPC wood plastic floor as an example, it has the following disadvantages: easy expansion or shrinkage deformation of finished products, large degree of warping, degumming easily and other issues.

### SUMMARY OF THE INVENTION

In order to solve the problems, the invention provides a hot-press molding formaldehyde-free stone-plastic composite plate; the main technical scheme is as follows:

A hot-press molding formaldehyde-free stone-plastic composite plate, comprising: a PVC material composite surface layer (1) as a surface layer, a stone-plastic material layer (2) as a middle layer and a PVC material bottom layer (3) as a bottom layer; wherein the PVC material composite surface layer (1), the stone-plastic material layer (2) and the PVC material bottom layer (3) are sequentially arranged from a surface side to a bottom side and hot-press molded into a plate body (L);

wherein the PVC material composite surface layer (1) is of a sheet-like structure, integrally hot-press molded and sequentially arranged from the bottom side to the surface side with a PVC sheet (101), a PVC decorative material (102), and a wear-resistant layer (103), and a surface side of the wear-resistant layer (103) is coated with a UV lacquer layer (104);

wherein the stone-plastic material layer (2) is of a sheet-like structure, extrusion-molded after compositing resin powder, calcium powder, stabilizer and additive;

wherein the PVC material bottom layer (3) is of a sheet-like structure, calendaring-molded or extrusion-molded after compositing plasticizer, resin powder, calcium powder, stabilizer, and additive.

Preferably, a further improvement is that the PVC sheet (101) is extrusion-molded or calendaring-molded after compositing plasticizers, resin powder, calcium powder, stabilizer, and additive.

Preferably, a further improvement is that a thickness of the PVC material composite surface layer (1) is between 0.5 mm to 3.5 mm, a thickness of a stone plastic material layer (2) is between 1.5 mm to 0.8 mm, and a thickness of the PVC material bottom layer (3) is between 0.5 mm to 3.5 mm.

Preferably, a further improvement is that a raised grain (106) is configured on a surface side of the PVC material composite surface layer (1).

Preferably, a further improvement is that a concave slot (4) is formed at a side in an extending direction of the length or width of the plate body (L), and a convex insertion tongue (5), matching and climbing the concave slot (4), is formed at another side of the extending direction of the length or width of the plate body (L).

Preferably, a further improvement is that a mortice (7) is formed at a side in an extending direction of the length or width of the plate body (L), and a tenon (6), matching and climbing the mortice (7), is formed at another side of the extending direction of the length or width of the plate body (L).

Preferably, a further improvement is that a concave groove (8) is configured around a peripheral side of the plate body (L), and a connection block (9) is configured inside the concave groove (8).

Preferably, a further improvement is that, wherein, the peripheral side of the plate body (L) is of a flat cutting structure and an overflow groove is formed on a bottom of the plate body (L).

Preferably, a further improvement is that, wherein, the plate body (L) is hot-press molded and sequentially arranged from the surface side to the bottom side with the PVC material composite surface layer (1) and stone-plastic material layer (2).

The positive effects of the above-mentioned technical solutions are:

1. By taking a sheet hot-press molded from the PVC sheet, PVC decorative fabrics, wear-resistant layer as the surface layer, a sheet, with a sheet structure, extrusion-molded or calendering-molded from resin powder, calcium powder, stabilizer and additive as the intermediate layer, and a sheet extrusion-molded or calendering-molded after compositing plasticizer, resin powder, calcium powder, stabilizer, and additive as the bottom sheet of PVC material, the finished products is good in stability, less in deformation, waterproof, fire-prevent, anti-skid, flame retardant, wear-resisting, shock-resistant, high-temperature-resistant, long in life and has other advantages;

2. The products are formaldehyde-free, environmental friendly and safe;

3. The periphery side of the plate body is provided with a snap-fit connection structure which is easy to assemble and disassemble, and the practicability of the product is greatly improved.

### BRIEF DESCRIPTIONS OF THE DRAWINGS

The accompanying drawings, together with the specification, illustrate exemplary embodiments of the present disclosure, and, together with the description, serve to explain the principles of the present invention.

FIG. 1 is a structure diagram of a hot-pressing molding formaldehyde-free stone-plastic composite plate in the embodiment;

FIG. 2 is a structure diagram of a composition of a hot-pressing molding formaldehyde-free stone-plastic composite plate in the embodiment;

FIG. 3 is a structure diagram of a hot-pressing molding formaldehyde-free stone-plastic composite plate provided with tenons and mortice in the embodiment;

FIG. 4 is a structure diagram of a hot-pressing molding formaldehyde-free stone-plastic composite plate provided with grooves and connection block in the embodiment;

FIG. 5 is a structure diagram of a hot-pressing molding formaldehyde-free stone-plastic composite plate having a flat cutting structure at the periphery side thereof in the embodiment.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “plurality” means a number greater than one.

Hereinafter, certain exemplary embodiments according to the present disclosure will be described with reference to the accompanying drawings.

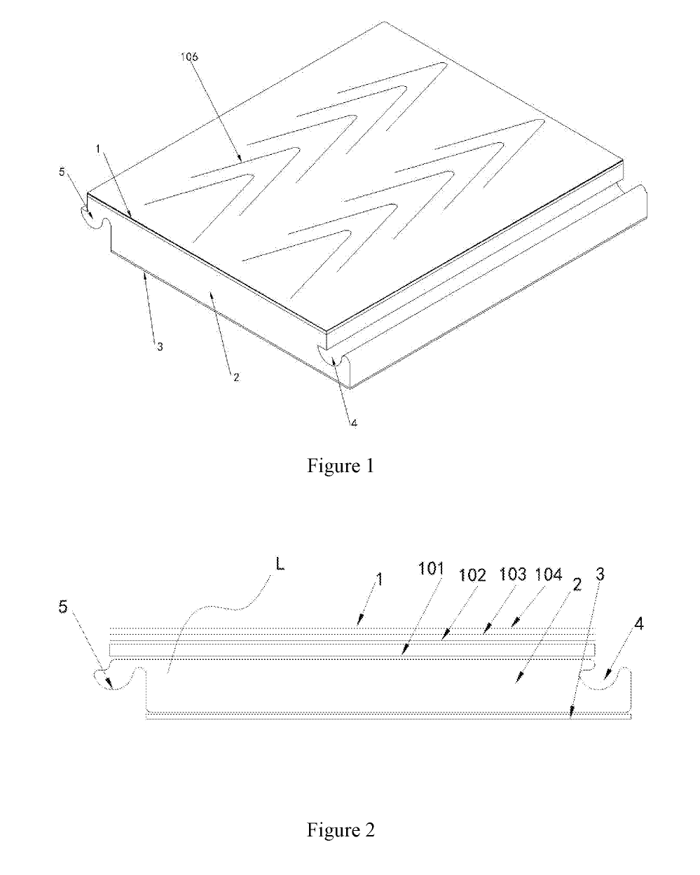

Referring to FIG. 1, FIG. 2, A hot-press molding formaldehyde-free stone-plastic composite plate, comprising: a PVC material composite surface layer 1 as a surface layer, a stone-plastic material layer 2 as a middle layer and a PVC material bottom layer 3 as a bottom layer; wherein the PVC material composite surface layer 1, the stone-plastic material layer 2 and the PVC material bottom layer 3 are sequentially arranged from a surface side to a bottom side and hot-press molded into a plate body L;

In this embodiment, the PVC material composite surface layer 1 is of a sheet-like structure, integrally hot-press molded and sequentially arranged from the bottom side to the surface side with a PVC sheet 101, a PVC decorative material 102, a wear-resistant layer 103, and a surface side of the wear-resistant layer 103 is coated with a UV lacquer layer (104);

In this embodiment, the stone-plastic material layer 2 is of a sheet-like structure, extrusion-molded after compositing resin powder, calcium powder, stabilizer and additive;

In this embodiment, the PVC material bottom layer 3 is of a sheet-like structure, calendaring-molded or extrusion-molded after compositing plasticizer, resin powder, calcium powder, stabilizer, and additive.

Preferably, the PVC sheet 101 of this application is extrusion-molded or calendaring-molded after compositing plasticizers, resin powder, calcium powder, stabilizer, and additive.

Preferably, in this embodiment, a thickness of the PVC material composite surface layer 1 is between 0.5 mm to 3.5 mm, a thickness of a stone plastic material layer 2 is between 1.5 mm to 0.8 mm, and a thickness of the PVC material bottom layer 3 is between 0.5 mm to 3.5 mm.

In order to slip and increase texture and improve the wear resistance of the product, a further improvement is that a raised grain (106) is configured on a surface side of the PVC material composite surface layer (1).

Referring to FIG. 1, for the plate body L as being used as plate, and ease of removal, a further improvement is that a concave slot 4 is formed at a side in an extending direction of the length of the plate body L, and a convex insertion tongue 5, matching and climbing the concave slot 4, is formed at another side of the extending direction of the length of the plate body L; it is also easy to understood that a concave slot 4 is formed at a side in an extending direction of the width of the plate body L, and a convex insertion tongue 5, matching and climbing the concave slot 4, is formed at another side of the extending direction of the width of the plate body L.

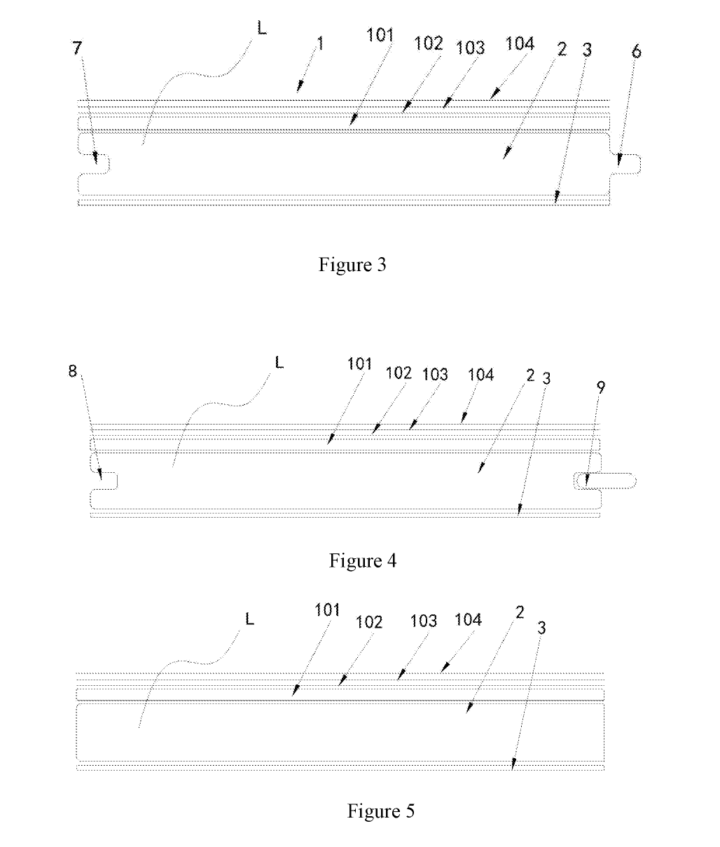

Referring to FIG. 3, for the plate body L as being used as plate, and ease of removal, the further improvement for the connection structure of the plate body L is that a mortice 7 is formed at a side in an extending direction of the length of the plate body L, and a tenon 6, matching and climbing the mortice 7, is formed at another side of the extending direction of the length of the plate body L; it can also be understood that a mortice 7 is formed at a side in an extending direction of the width of the plate body L, and a tenon 6, matching and climbing the mortice 7, is formed at another side of the extending direction of the width of the plate body L.

Referring to FIG. 4, for the plate body L as being used as plate, and ease of removal, the further improvement for the connection structure of the plate body L is that a concave groove 8 is configured around a peripheral side of the plate body L, and a connection block 9 is configured inside the concave groove 8, and when connecting, the connection between the adjacent plate bodies L is completed by connecting two end of the connection block into the groove 8 of the adjacent plate body.

Referring to FIG. 5, for the plate body L as being used as plate, the further improvement for the connection structure of the plate body L is that the peripheral side of the plate body L is of a flat cutting structure and an overflow groove is formed in the bottom of the plate body L (no reference in the figures), and the installing and fixing can be completed after connecting sequentially through applying glue on the bottom.

In order to reduce cost and the weight of the plate body, the plate body L can also be directly hot-press molded and sequentially arranged from the surface side to the bottom side with the PVC material composite surface layer 1 and stone-plastic material layer 2.

The hot-press molding formaldehyde-free stone-plastic composite plate has four ways to composite, the first is thermoplastic fusion laminated one-time molding; the second is the hot-press molding of the PVC material surface in advance, and then bonding with the stone plastic composite layer and the bottom layer of PVC material; the third is a thermoplastic fusion laminating one-time molding without PVC material bottom; the forth is that after the PVC material surface layer being hot-press molded in advance, bonding with the stone-plastic composite layer without PVC material bottom layer. At the same time, in order to improve the practical application needs of different fields, the bottom of the plate body L may be compounded with various other facing materials (such as cushion, decorative paper, decorative film or other similar materials).

The foregoing is only the preferred embodiments of the invention, not thus limiting embodiments and scope of the invention, those skilled in the art should be able to realize that the schemes obtained from the content of specification and figures of the invention are within the scope of the invention.

1. A hot-press molding formaldehyde-free stone-plastic composite plate, comprising: a PVC material composite surface layer as a surface layer, a stone-plastic material layer as a middle layer and a PVC material bottom layer as a bottom layer; wherein the PVC material composite surface layer, the stone-plastic material layer and the PVC material bottom layer are sequentially arranged from a surface side to a bottom side and hot-press molded into a plate body;
wherein the PVC material composite surface layer is of a sheet-like structure, integrally hot-press molded and sequentially arranged from the bottom side to the surface side with a PVC sheet, a PVC decorative material, and a wear-resistant layer, and a surface side of the wear-resistant layer is coated with a UV lacquer layer;
wherein the stone-plastic material layer is of a sheet-like structure, extrusion-molded after compositing resin powder, calcium powder, stabilizer and additive;
wherein the PVC material bottom layer is of a sheet-like structure, calendaring-molded or extrusion-molded after com positing plasticizer, resin powder, calcium powder, stabilizer, and additive.

2. The hot-press molding formaldehyde-free stone-plastic composite plate according to claim 1, wherein the PVC sheet is extrusion-molded or calendaring-molded after compositing plasticizers, resin powder, calcium powder, stabilizer, and additive.

3. The hot-press molding formaldehyde-free stone-plastic composite plate according to the claim 1, wherein a thickness of the PVC material composite surface layer is between 0.5 mm to 3.5 mm, a thickness of a stone plastic material layer is between 1.5 mm to 0.8 mm, and a thickness of the PVC material bottom layer is between 0.5 mm to 3.5 mm.

4. The hot-press molding formaldehyde-free stone-plastic composite plate according to claim 1, wherein a raised grain is configured on a surface side of the PVC material composite surface layer.

5. The hot-press molding formaldehyde-free stone-plastic composite plate according to claim 1, wherein a concave slot is formed at a side in an extending direction of the length or width of the plate body, and a convex insertion tongue, matching and climbing the concave slot, is formed at another side of the extending direction of the length or width of the plate body.

6. The hot-press molding formaldehyde-free stone-plastic composite plate according to claim 1, wherein a mortice is formed at a side in an extending direction of the length or width of the plate body, and a tenon, matching and climbing the mortice, is formed at another side of the extending direction of the length or width of the plate body.

7. The hot-press molding formaldehyde-free stone-plastic composite plate according to claim 1, wherein a concave groove is configured around a peripheral side of the plate body, and a connection block is configured inside the concave groove.

8. The method according to claim 1, wherein a peripheral side of the plate body is of a flat cutting structure and an overflow groove is formed on a bottom of the plate body.

9. The hot-press molding formaldehyde-free stone-plastic composite plate according to claim 1, wherein the plate body is hot-press molded and sequentially arranged from the surface side to the bottom side with the PVC material composite surface layer and stone-plastic material layer.

10. The hot-press molding formaldehyde-free stone-plastic composite plate according to claim 3, wherein a raised grain is configured on a surface side of the PVC material composite surface layer.
